(19) United States
(12) Patent Application Publication
(10) Pub. No.: US 2006/0167848 A1
(43) Pub. Date: Jul. 27, 2006

(54) Method and system for query generation in a task based dialog system

(76) Inventors: Hang S. Lee, Palatine, IL (US); William K. Thompson, Evanston, IL (US)

Correspondence Address: MOTOROLA, INC., 1303 EAST ALGONQUIN ROAD, IL01/3RD, SCHAUMBURG, IL, 60196, US

(21) Appl. No.: 11/043,837

(22) Filed: Jan. 26, 2005

(51) Int. Cl. G06F 7/00

(52) U.S. Cl. 707/3

(57) ABSTRACT

A method for querying a database (106) in a task based dialog system (102) is provided. The task based dialog system (102) comprises a task model (110), a user model (114), a dialog manager (112), a query generator (116), and a mapper (120). The method interprets a user input required b complete a task. A query is generated for querying the database (106). If the generated query is not suitable for querying the database (106) it is converted to a suitable query. The suitable query is executed to complete the task.

### FIELD OF THE INVENTION

This invention is in the field of dialog system and more specifically is in the field of query generation in a task based dialog system.

### BACKGROUND

Task based dialog systems are systems that interact with a user to complete one or more tasks such as retrieving information, conducting transactions, and other such problem solving tasks. A set of interactions between a user and a task based dialog system is referred to as a dialog. Each interaction is referred to as a turn of the dialog. The information provided by either the user or the task based dialog system is referred to as a context of the dialog. The task based dialog system has a set of pre-defined task parameters required for completing a task. The user specifies the value of a task parameter through an input device, such as touch-sensitive screen or mouse or keypad.

Typically, the task parameters are interdependent based upon their values. Interdependencies between task parameters are defined in a database. The task based dialog system discovers these interdependences to complete a task. The task based dialog system queries the database to discover such interdependencies.

The task based dialog system uses the values of the task parameters provided by the user as templates for matching data from the database. For example, a user wishes to perform a task of searching for hotels by defining the city area and price range. The task based dialog system then queries the database to obtain the details of hotels and uses them to complete the task.

The conventional task based dialog systems are domain dependent The domain dependent task models rely on specific heuristics of the domain of the application to which the task based dialog system is applied. Conventional task based dialog systems need to be designed for every application. Therefore, conventional task based dialog systems cannot be adopted for different application domains. Further, conventional task based dialog systems are dependent on the storage format of the database.

### BRIEF DESCRIPTION OF THE DRAWINGS

The present invention is illustrated by way of example, and not limitation, by the accompanying figures, in which like references indicate similar elements, and in which:

FIG. 1 is a block diagram of a task based dialog system, in accordance with some embodiments of the present invention;

FIG. 2 is a block diagram of a dialog manager, in accordance with some embodiments of the present invention;

FIG. 3 shows a flow chart that illustrates the different steps of the method for querying a database in the task based dialog system, in accordance with some embodiments of the present invention; and

FIG. 4 is a block diagram of an electronic equipment for query generation, in accordance with some embodiments of the present invention.

Those skilled in the art will appreciate that the elements in the figures are illustrated for simplicity and clarity, and have not been necessarily drawn to scale. For example, the dimensions of some of the elements in the figures may be exaggerated, relative to other elements, for improved perception of the embodiments of the present invention.

### DETAILED DESCRIPTION OF THE DRAWINGS

Before describing in detail a method and system for querying a database in a task based dialog system, in accordance with embodiments of the present invention, it should be observed that the embodiments of the present invention reside primarily in combinations of method steps and apparatus components related to task based dialog system. Accordingly, the apparatus components and method steps have been represented, where appropriate, by conventional symbols in the drawings. These drawings show only the specific details that are pertinent for understanding the present invention, so as not to obscure the disclosure with details that will be apparent to those with ordinary skill in the art and the benefit of the description herein.

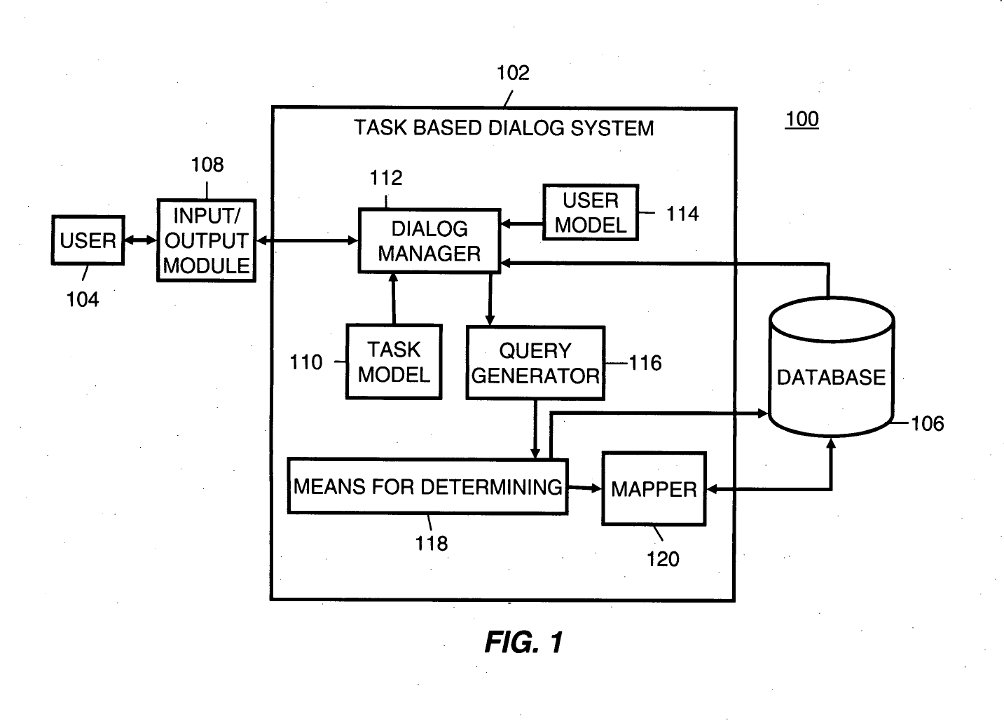

Referring to FIG. 1, a block diagram shows a representative environment 100 in which the present invention may be practiced, in accordance with some embodiments of the present invention. The representative environment 100 includes a task based dialog system 102, a user 104, a database 106, and an input/output device 108. The task based dialog system 102 interacts with the user 104 to complete a task that the user 104 wishes to perform. During the interaction, the user 104 provides input required for completing the task. The user 104 provides the input through the input/output device 108. The input/output device 108 can be a user interface, such as a computer monitor, a touch screen, a keyboard, a microphone (for automatic speech recognition), or a combination thereof. The interaction between-the user 104 and the task based dialog system 102 is referred to as a dialog. Each dialog comprises a number of interactions between the user 104 and the task based dialog system 102. Each interaction is referred to as a turn of the dialog. The information provided by the user 104 or by the task based dialog system 102 at each turn of the dialog is referred to as a context of the dialog. The task based dialog system 102 maintains and updates the contexts of the dialog. The database 106 stores data for completion of the task provided by the user 104. Examples of the database 106 include an XML database and a relational database. The task based dialog system 102 queries the database 106 to complete the task. The task based dialog system 102 provides the result of the queries to the user 104. The task based dialog system 102 provides the result to the user 104 through the input/output device 108. The task based dialog system 102 is not dependent on particular information of a domain that utilizes the task based dialog system 102.

The user 104, for example, wishes to perform a task of booking a hotel room. The user 104 provides city area and price range as input to the task based dialog system 102. The task based dialog system 102 uses these two inputs to query the database 106 and obtain details of hotels. These details are used to complete the task through further dialog with the user 104.

FIG. 1 also shows components of the task based dialog system 102. The task based dialog system 102 comprises a task model 110, a dialog manager 112, a user model 114, a query generator 116, a means for determining 118, and a mapper 120. The dialog manager 112 interprets the input provided by the user 104 using the task model 110, the user model 114 and the context of the dialog. The dialog manager 112 makes a template based on the interpretation of the input provided by the user 104. The template contains input provided by the user 104 in a structural form that can be used for generating a query. The dialog manager 112 provides the template to the query generator 116. The query generator 116 generates a first query using the template provided by the dialog manager 112. In one embodiment of the present invention, the query generator 116 generates the first query in XQuery. The means for determining 118 determines whether the first query is suitable for querying the database 106. A query in a language that can be used for querying a database is referred to as suitable for querying the database, for example, only a query in SQL may be used for querying a relational database. Therefore, the query in SQL is suitable for the relational database. The means for determining 118 can be implemented as software, hardware, or a combination thereof. If the first query is suitable for querying the database 106, the database 106 is queried using the first query. If the first query is not suitable for querying the database 106, in one embodiment of the present invention, the mapper 120 converts the first query to a second query, which is suitable for querying the database 106. In one embodiment of the present invention, the second query is a query in SQL. Examples of the mapper 120 include an XQuery to SQL mapper, and a SQL to XQuery mapper. The database 106 is then queried using of the second query. The results obtained by querying the database 106 are provided to the dialog manager 112.

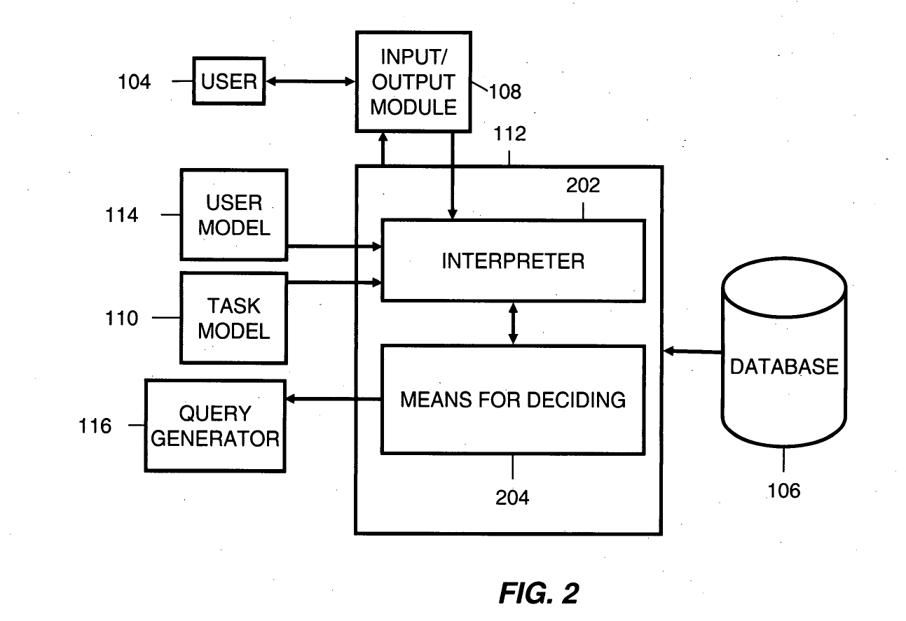

Referring to FIG. 2, a block diagram shows the dialog manager 112, in accordance with some embodiments of the present invention. The dialog manager 112 comprises an interpreter 202 and a means for deciding 204. The interpreter 202 accepts and interprets the input provided by the user 104. The interpreter 202 uses the context of the dialog, the task model 110, and the user model 114 to interpret the input. The interpreter 202 can use context of the ongoing dialog with the user 104 or the context of the stored dialogs. The task model 110 is a data structure used to model a task that the task based dialog system 102 can perform. The user model 114 specifies the relative ranking of the input provided by the user 104. The interpreter 202 provides the interpretation to the means for deciding 204. The means for deciding 204, based on interpretation provided by the interpreter 202, performs a check to decide whether the first query can be generated for querying the database 106. The means for deciding 204 further decides the type of the first query. The first query can be a parameter completion query or a template search query. The means for deciding 204 can be implemented as software, hardware, or a combination thereof.

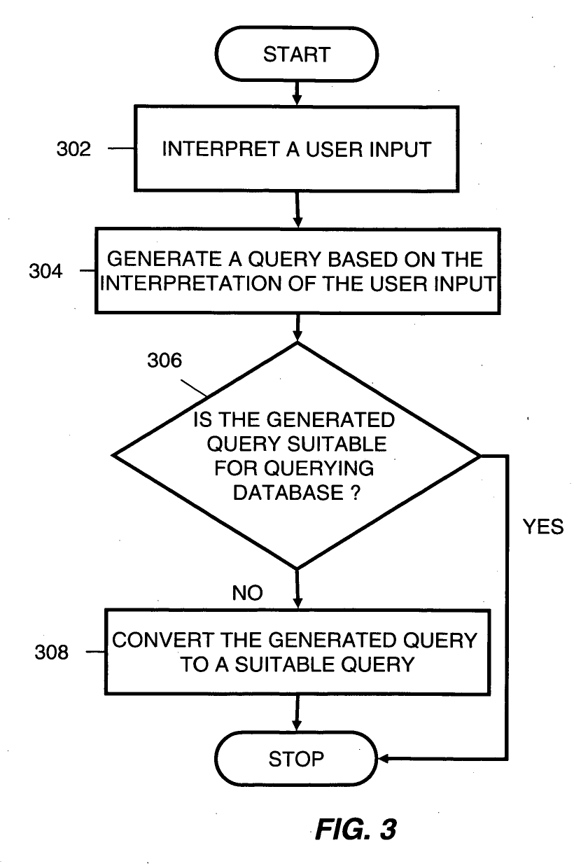

Referring to FIG. 3, a flow chart shows some steps of a method for querying the database 106 in the task based dialog system 102, in accordance with some embodiments of the present invention. The method is not dependent on particular information of a domain that utilizes the method. At step 302, the dialog manager 112 accepts and interprets input provided by the user 104 for a task selected by the user 104. The user 104 selects the task from a task model schema. The task model schema specifies tasks that the user 104 can perform. Examples of the task include retrieving information, conducting a transaction, and other such problem solving tasks. The task model schema also specifies task parameters required to complete each of the tasks. Examples of the task model schema include, but are not limited to, an Extensible Markup Language (XML) schema and a Document Type Definition (DTD) schema. The user 104 interacts with the task based dialog system 102 to provide input about the task. Further, the user 104 provides values of the task parameters required to complete the task. The dialog manager 112 interprets the input using the context of the dialog, the task model 110, and the user model 114. Context of the current dialog or the context of the stored dialogs can be used by the dialog manager 112 for interpreting the input provided by the user 104.

The task model 110 is a data structure used to model a task that the task based dialog system 102 can perform. The task model 110 is developed using the task model schema. The task model 110 consists of a number of tasks that an application using the task based dialog system 102 can perform. For each task, there are one or more plans that can be used by the application. A plan for a task is also referred to as a recipe. Each recipe in turn comprises a number of steps that needs to be performed for completing the task. Each step of a recipe is also referred to as a task act. Further, the recipe contains constraints on the execution of the task acts, such as their temporal order and whether a task act can be repeated or not. Each task act in turn comprises a number of task parameters that have to be specified for completing the task. Each task parameter corresponds to an instance of an object in the domain to which the task based dialog system 102 is applied. A task parameter can be classified as an atomic parameter or as a complex parameter. A task parameter that has only one attribute attached to it is classified as an atomic parameter. A parameter that has a number of attributes attached to it is classified as a complex parameter. Task model domain objects in the task model 110 have structure that is isomorphic to the structure of the database 106.

The user model 114 specifies the relative ranking of the parameters of the task model 110, which have values specified by the user 104. It provides information to the dialog manager 112 on what task parameters need to be requested from a given user during a dialog before a query is generated, based on user preferences and profiles built from previous dialogs.

The dialog manager 112, based on the interpretation of the input provided by the user 104, performs a check to determine whether a first query can be generated for querying the database 106. For example, the dialog manager 112 can decide to ask the user 104 for more parameter values, based on the user model 114, before generating the first query to the database 106. Further, the dialog manager 112, based on the interpretation of the input provided by the user 104, decides the type of the first query to generate. The first query generated by the dialog manager 112 can be a parameter completion query or a template search query.

A query generated to complete a partially specified parameter of a task act is referred to as the parameter completion query. A query generated to complete a task, based on the parameters that are completely specified by the user 104, is referred to as the template search query.

The dialog manager 112 makes a template based on the values of the parameters of the task model 110 provided by the user 104. The template is used to generate the first query for querying the database 106. The dialog manager 112, after deciding the type of the first query to generate for querying the database 106, invokes the query generator 116. The dialog manager 112 provides the template to the query generator 116.

At step 304, the query generator 116 generates the first query of the type decided by the dialog manager 112. The query generator 116 generates the first query by using the template provided by the dialog manager 112.

At step 306, the means for determining 118 determines whether the first query is suitable for querying the database 106. A query in a language that can be used for querying a database is considered as suitable for querying the database, for example, only a query in SQL can be used for querying a relational database. Therefore, the query in SQL is suitable for the relational database. If the first query is suitable for querying the database 106, the database 106 is queried using the first query. If the first query is not suitable for querying the database 106, at step 308, the mapper 120 converts the first query to a second query, which is suitable for querying the database 106. The query generator 116, for example, generates the first query in XQuery and the database 106 is a relational database. The mapper 120 converts the first query to the second query. The second query is a query in a language that can be used for querying the relational database, for example, the second query is a query in SQL. The database 106 is then queried using the second query. The results obtained by querying the database 106 are returned to the dialog manager 112 for completing the task. The dialog manager 112 completes the task and provides the result to the user 104 through input/output device 108.

An exemplary task model is illustrated below.

```
<!DOCTYPE AIMModel SYSTEM “../resources/AimModel.dtd”>
<AIMModel>
  <DomainModel>
    <PrimitiveType type=“string”></PrimitiveType>
    <DomainObject type=“Flight” >
      <Attribute name=“deptCity” type=“City”></Attribute>
      <Attribute name=“deptTime” type=“City”></Attribute>
      <Attribute name=“arrCity” type=“Date”></Attribute>
      <Attribute name=“arrTime” type=“Date”></Attribute>
      <Constraint type=“not”
        <Constraint type=“and”
          <Constraint type=”equals”
        arg=“deptCity.name”
        arg=“arrCity.name”>
          </Constraint>
          <Constraint type=“equals”
        arg=“deptCity.state”
        arg=“arrCity.state”>
          </Constraint>
        </Constraint>
      </Constraint>
          <Constraint type=“precedes”
        arg=“deptDate.time”
        arg=“arrDate.time”>
          </Constraint>
    </DomainObject>
    <DomainObject type=“City”>
      <Attribute name=“name” type=“string”></Attribute>
      <Attribute name=“state” type=“string”></Attribute>
    </DomainObject>
    <DomainObject type=“Date”>
      <Attribute name=“time” type=“string”></Attribute>
      <Attribute name=“day” type=“string”></Attribute>
      <Attribute name=“month” type=“string”></Attribute>
      <Attribute name=“year” type=“string”></Attribute>
    </DomainObject>
    </DomainModel>
    <TaskModel name=“LookupFlightTaskModel”>
      <TaskAct isa=“complex” type=“LookupFlight”>
        <TaskParam name=“flight” type=“Flight”/>
      </TaskAct>
      <TaskAct isa=“complex” type=“SpecifyDeptCity”>
        <TaskParam name=“deptCity” type=“City”/>
      </TaskAct>
    <TaskAct isa=“complex” type=“SpecifyArrCity”>
      <TaskParam name=“arrCity” type=“City”/>
    </TaskAct>
    <TaskAct isa=“complex” type=“SpecifyDeptDate”>
      <TaskParam name=“deptDate” type=“Time”/>
    </TaskAct>
    <TaskAct isa=“complex” type=“SpecifyArrCity”>
      <TaskParam name=“arrDate” type=“Time”/>
    </TaskAct>
    <Recipe achieves=“LookupFlight” name=“LookupFlightRecipe” >
      <step name=“step1” type=“SpecifyDeptCity ”/>
      <step name=“step2” type=“SpecifyDeptDate”/>
      <step name=“step3” type=“SpecifyArrCity”/>
      <step name=“step4” type=“SpecifyArrTime”/>
      <step name=“step5” type=“FindMatchingFlights”/>
    </Recipe>
  </TaskModel>
</IAMModel>
```

The task specified in the above task model is ‘LookupFlight’, i.e. the user 104 wants information about a flight. The ‘LookupFlightRecipe’ recipe is used to perform the ‘LookupFlight’ task. The ‘LookupFlightRecipe’ comprises ‘SpecifyDeptCity’, ‘SpecifyDeptDate’, ‘SpecifyArrCity’, ‘SpecifyArrDate’, and ‘FindMatchingFlights’ as task acts. The task acts ‘SpecifyDeptCity’, ‘SpecifyDeptDate’, ‘SpecifyArrCity’, ‘SpecifyArrDate’ and ‘FindMatchingFlights’ are respectively used for specifying departure city, specifying departure date, specifying arrival city, specifying arrival date, and finding the matching flight respectively. The ‘LookupFlightRecipe’ has constraints on the departure date, the arrival date, a set of values for the parameters of the task act ‘SpecifyDeptCity’, a set of values for the parameters of the task act ‘SpecifyArrCity’, and the order in which the task acts are to be performed. In the ‘LookupFlightRecipe’, the departure date always precedes the arrival date, the set of values for the parameters of the task act ‘SpecifyDeptCity’ cannot be same as the set of values for the parameters of the task act ‘SpecifyArrCity’, and the task acts are to be performed in the order specified in ‘LookupFlightRecipe’. The task act ‘SpecifyDeptCity’ requires the name of the departure city and name of the departure state as values for the parameters. The task act ‘SpecifyDeptDate’ requires departure time, departure day, departure month, and departure year as values for the parameters. The task act ‘SpecifyArrCity’ requires the name of the arrival city and the arrival state as values for the parameters. The task act ‘SpecifyArrDate’ requires arrival time, arrival day, arrival month, and arrival year as values for the parameters. The task act ‘FindMatchingFlights’ uses the values of the parameters specified for the task acts ‘SpecifyDeptCity’, ‘SpecifyDeptDate’, ‘SpecifyArrCity’, and ‘SpecifyArrDate’ to find the matching flight. Exemplary data for completing the ‘Flight’ object of the above task model, stored in the database 106 is shown below.

```
<Flight>
    <deptCity>
    <City>
        <name>Portland</name>
        <state>Oregon</state>
      </City>
    </deptCity>
    <deptDate>
    <Date>
        <time>3PM</time>
        <day>13</day>
        <month>October</month>
        <year>2004</year>
    </Date>
    </deptDate>
    <arrCity>
    <City>
        <name>Portland</name>
        <state>Maine</state>
    </City>
    </arrCity>
    <arrDate>
    <Date>
        <time>9PM</time>
        <day>13</day>
        <month>October</month>
        <year>2004</year>
    </Date>
    </arrDate>
</Flight>
```

Task model domain objects in the above task model have structure that is isomorphic to the structure of the database 106. For example, the information stored in the database 106 is in XML format, then each parameter type and each of its attributes is matched to an XML element. Further, for the atomic type parameters, i.e., those containing string values such as the name of a departure city, the value is stored in the text of the XML element. For the complex type parameters, i.e. those containing another domain objects such as the departure time, the XML element corresponding to the object that has a value is used as the child element of the element corresponding to the complex type parameter. Another exemplary task model is illustrated below.

```
<!DOCTYPE AIMModel SYSTEM “../resources/AimModel.dtd”>
<AIMModel>
  <DomainModel>
    <PrimitiveType type=“string”></PrimitiveType>
    <DomainObject type=“PhoneBookEntry” >
      <Attribute name=“firstname” type=“string”></Attribute>
      <Attribute name=“lastname” type=“string”></Attribute>
      <Attribute name=“homephone” type=“string”></Attribute>
      <Attribute name=“address” type=“Address”></Attribute>
      </DomainObject>
      <DomainObject type=“Address”>
      <Attribute name=“number” type=“string”></Attribute>
      <Attribute name=“street” type=“string”></Attribute>
      <Attribute name=“city” type=“string”></Attribute>
      </DomainObject>
      </DomainModel>
  <TaskModel name=“PhoneBookTaskModel”>
    <TaskAct isa=“objective”>
      </TaskAct>
      <TaskAct isa=“complex” type=“AddEntry”>
      </TaskAct>
      <TaskAct isa=“complex” type=“FindEntry” >
      <TaskParam name=“field” type=“PhoneBookEntry”/>
      </TaskAct>
      <TaskAct isa=“atomic” type=“FindField” >
      <TaskParam name=“field” type=“PhoneBookEntry”>
      </TaskParam>
      </TaskAct>
      <Recipe achieves=“FindEntry” name=“FindEntryRecipe” >
        <step name=“FindEntryStep1” type=“FindField”/>
        <step name=“FindEntryStep2” type=“Finish”/>
      </Recipe>
  </TaskModel>
</IAMModel>
```

The tasks specified in the above task model are ‘Add Entry’ and ‘Find Entry’, i.e., the user 104 either wants to add or wants to find an entry in a phonebook. The ‘FindEntryRecipe’ recipe is used to perform the ‘Find Entry’ task. The ‘FindEntryRecipe’ recipe has ‘Find Field’, and ‘Finish’ as task acts. The task acts ‘Find Field’ and ‘Finish’ are respectively used for specifying data about the entry that is to be found in the phonebook, and for completing the task. The ‘FindEntryRecipe’ has a constraint on the order in which the task acts are to be performed. As a constraint, the task acts are to be performed in the order specified in the ‘FindEntryRecipe’. The ‘Find Entry’ is of the complex type and requires first name, last name, home phone number, and address as values for the parameters. Further, the address is of the complex type and requires house number, street name, and city name as values of the parameters. Exemplary data for completing the ‘PhoneBookEntry’ object of the above task model, stored-in the database 106 is shown below.

```
<PhoneBookEntry>
    <firstname>raymond</firstname>
    <lastname>lee</lastname>
    <homephone>1234567890</homephone>
    <address>
        <Address>
            <number>1295</number>
            <street>Algonquin Rd.</street>
            <city>Schaumburg</city>
        </Address>
    </address>
</PhoneBookEntry>
```

The user 104 sometimes partially specifies a parameter during a dialog, for example, for the ‘LookupFlight’ task, the task based dialog system 102 in a dialog with the user 104 asks the user 104 ‘What is the departure city?’ and the user 104 responds with ‘Portland’. The task act ‘SpecifyDeptCity’ requires the name of the departure city and the name of the departure state as values for the parameters. The input provided by the user 104 specifies only the name of the departure city and hence partially specifies the values for the parameters of the task act ‘SpecifyDeptCity’. A partially specified parameter for the task model corresponding to the “LookupFlight’ task updated with input provided by the user 104 is shown below.

```
<Flight>
    <deptCity>
        <City>
            <name>Portland</name>
        </City>
    </deptCity>
</Flight>
```

To complete the values of the parameters of the task act ‘SpecifyDeptCity’, the dialog manager 112 decides to generate a parameter completion query. The parameter completion query would retrieve the states of the cities named ‘Portland’ in the database 106.

A query can be generated for completing a task if the user 104 provides completely specified parameters, for example, for the task model corresponding to the ‘LookupFlight’ task, the values for the parameters of the ‘LookupFlight’ task are completely specified by the user 104. An exemplary input that is fully specified by the user 104 for the ‘LookupFlight’ task is shown below.

```
<Flight>
    <deptCity>
    <City>
        <name>Portland</name>
        <state>Oregon</state>
    </City>
    </deptCity>
    <deptDate>
    <Date>
        <time>3PM</time>
        <day>13</day>
        <month>October</month>
        <year>2004</year>
      </Date>
    </deptDate>
    <arrCity>
    <City>
        <name>Portland</name>
        <state>Maine</state>
    </City>
    </arrCity>
    <arrDate>
      <Date>
        <time>9PM</time>
        <day>13</day>
        <month>October</month>
        <year>2004</year>
      </Date>
    </arrDate>
</Flight>
```

To complete the ‘LookupFlight’ task, the dialog manager 112 decides to generate a template search query. The template search query would retrieve all the flights from the database 106 that have ‘Portland’ as departure city, ‘Oregon’ as departure state, ‘Portland’ as arrival city, ‘Maine’ as arrival state, departure time ‘3 PM’, departure day ‘13’, departure month ‘October’, departure year ‘2004’, arrival time ‘9 PM’, arrival day ‘13’, arrival month ‘October’, arrival year ‘2004’.

The query generator 116 generates the query decided by the dialog manager 112. An exemplary parameter completion query generated to complete the partially specified values of the parameters of the task act ‘SpecifyDeptCity’ of the above example is illustrated below.

for $city in document(“flights.xml”)/deptCity
where $city/name=“Portland”
return $city

An exemplary template search query generated to complete the “LookupFlight’ task of the above example is illustrated below.

for $flight in document(“flights.xml”)
where $deptCity/name=“Portland”
AND $flight/deptCity/state=“Oregon”
AND $flight/deptDate/time=“3PM”
AND $flight/deptDate/day=“13”
AND $flight/deptDate/month=“October”
AND $flight/deptDate/year=“2004”
AND $flight/arrCity/name=“Portland”
AND $flight/arrCity/state=“Maine”
AND $flight/arrDate/time=“9PM”
AND $flight/arrDate/day=“13”
AND $flight/arrDate/month=“October”
AND $flight/arrDate/year=“2004”
return $flight

If the query generated by the query generator 116 is suitable for querying the database 106, the database 106 is queried using the query. The result obtained by querying an XML database with the above parameter completion query of the above example is shown below.

```
<City>
    <name>Portland</name>
    <state>Oregon</state>
</City>
<City>
    <name>Portland</name>
    <state>Maine</state>
</City>
```

The above parameter completion query has resulted in two values for the name of the departure state. The two values for the name of the departure city are obtained because there are two states in the database that have a city with the name ‘Portland’. An additional constraint on the name of the departure state can be put in the ‘LookupFlightRecipe” recipe to get only one result. An exemplary parameter completion query to complete the partially specified values of the parameters for the task act ‘SpecifyDeptCity’ with constraint on the name of the departure state in the above example is illustrated below.

for $city in document(“flights.xml”)/deptCity
where $city/name=“Portland”
AND (not(and ($city/name=“Portland”) ($city/state=“Maine”))
return $city

The result obtained by querying the XML database with above parameter completion query is shown below.

```
<City>
  <name>Portland</name>
  <state>Oregon</state>
</City>
```

A relational database cannot be queried with the above parameter completion query and the template search query as these are in XQuery. The above parameter completion query and the template search query are then converted to a suitable query by the mapper 120, for example, the above parameter completion query for the ‘LookupFlight’ task is converted by the mapper 120 to a query in SQL. An exemplary template search query in XQuery after conversion into the query in SQL is illustrated below.

SELECT DEPCITY.STATE
FROM FLIGHT, CITY, STATE
WHERE DEP.CITY.NAME=“Portland”
AND (NOT(AND (DEP.CITY.NAME=“PORTLAND”)
(DEP.CITY.STATE=“MAINE”))

The query in SQL is then used for querying the relational database. The results obtained by querying the database 106 are provided to the user 104 through the input/output device 108, for example, ‘Oregon’ will be obtained as a result of querying the database 106 and will be provided to the user 104.

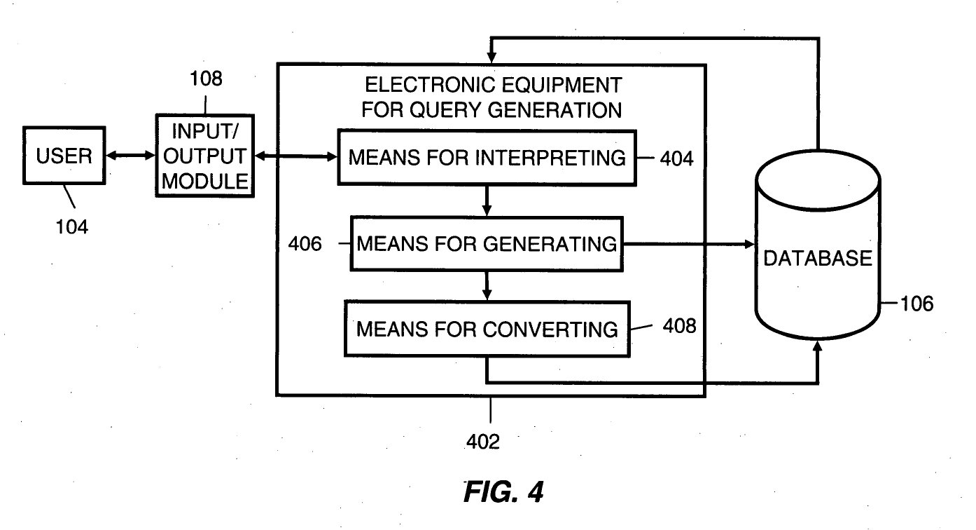

Referring to FIG. 4, a block diagram shows an electronic equipment 402 for query generation, in accordance with some embodiments of the present invention. The electronic equipment 402 comprises a means for interpreting 404, a means for generating 406, and a means for converting 408. The means for interpreting 404 accepts and interprets input provided by the user 104. The means for interpreting 404 performs a check to decide whether the first query can be generated based on the input Further, the means for interpreting 404 decides the type of first query. The means for interpreting 404 provides the interpretation to the means for generating 406. The means for generating 406 generates the first query based on the interpretation. The means for converting 408 performs a check to decide whether the first query is suitable for querying the database 106. If the first query is suitable for querying the database 106, the database 106 is queried using the first query. If the first query is not suitable for querying the database 106, in one embodiment of the present invention, the means for converting 408 converts the first query to a second query, which is suitable for querying the database 106. The database 106 is then queried using the second query. The results obtained by querying the database 106 are provided to the electronic equipment 402.

It should to be noted that all the codes shown are only for illustrative purposes. The codes may be represented in other formats without deviating from the spirit and scope of the present invention.

It will be appreciated that the method for querying a database in a task based dialog system described herein, may comprise one or more conventional processors and unique stored program instructions that control the one or more processors to implement some, most, or all of the functions described herein; as such, the functions of determining whether a query is suitable for querying a database may be interpreted as being steps of the method. Alternatively, the same functions could be implemented by a state machine that has no stored program instructions, in which each function or some combinations of certain portions of the functions are implemented as custom logic. A combination of the two approaches could be used. Thus, methods and means for performing these functions have been described herein.

The method for querying a database as described herein can be used in embedded devices and enterprise applications. For example, a handset where a user can input with speech, keypad, or a combination of both. The method can also be used in embedded devices for personal communication systems (PCS). The method can be used in commercial equipments ranging from extremely complicated computers to robots to simple pieces of test equipment, just to name some types and classes of electronic equipment. Further, the range of applications extends to all areas where access to information and browsing takes place with a multi-modal interface.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded, in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

As used herein, the terms “comprises”, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

A “set” as used herein, means a non-empty set (i.e., for the sets defined herein, comprising at least one member). The term “another”, as used herein, is defined as at least a second or more. The term “having”, as used herein, is defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system. It is further understood that the use of relational terms, if any, such as first and second, top and bottom, and the like are used solely to distinguish one entity or action from another entity or action without necessarily requiring or implying any actual such relationship or order between such entities or actions.

What is claimed is:

1. A method for querying a database, the database storing data for completion of a task in a task based dialog system, the method comprising:
interpreting a user input based on a task model and a dialog context to form an interpretation of the user input the dialog context comprising information provided by at least one of the user and the task based dialog system;
generating a first query based on the interpretation of the user input; and
when the first query is not directly suitable for querying the database, converting the first query to a second query that is directly suitable for querying the database.

2. The method for querying a database according to claim 1 wherein the method is domain independent.

3. The method for querying a database according to claim 1 wherein the database is from a group of databases consisting of an XML database and a relational database.

4. The method for querying a database according to claim 1 wherein the first query is in XQuery.

5. The method for querying a database according to claim 1 wherein the second query is in Structured Query Language SQL).

6. The method for querying a database according to claim 1 wherein interpreting the user input further comprises:
checking whether the first query can be generated based on the user input; and
deciding the type of the first query to generate based on the user input

7. The method for querying a database according to claim 1 wherein the first query is from a group of queries consisting of a template search query and a parameter completion query.

8. The method for querying a database according to claim 1 wherein generating the first query further comprises using a template.

9. A method for querying a database, the database storing data for completion of a task in a task based dialog system, the method comprising:
interpreting a user input based on a task model and a dialog context to form an interpretation of the user input the dialog context comprising information provided by at least one of the user and the task based dialog system; and
generating a query in XQuery based on the interpretation of the user input

10. A task based dialog system, the task based dialog system querying a database, the task based dialog system comprising:
a task model, the task model modeling a task in the task based dialog system;
a dialog manager, the dialog manager managing a dialog;
a query generator, the query generator generating a first query for the dialog; and
a mapper, the mapper converting the first query to a second query.

11. The task based dialog system according to claim 10 further comprising means for determining whether the first query is suitable for querying the database.

12. The task based dialog system according to claim 10 wherein the system is domain independent.

13. The task based dialog system according to claim 10 wherein the database is from a group of databases consisting of an XML database and a relational database.

14. The task based dialog system according to claim 10 wherein the dialog manager further comprises:
an interpreter, the interpreter interpreting a user input based on a task model and a dialog context to form an interpretation of the user input, the dialog context comprising information provided by at least one of the user and the task based dialog system; and
means for deciding when to generate the first query and what type of the first query to generate.

15. The task based dialog system according to claim 10 wherein the first query is in XQuery.

16. The task based dialog system according to claim 10 wherein the second query is in Structured Query Language (SQL).

17. The task based dialog system according to claim 10 wherein the fist query is from a group of queries consisting of a template search query and a parameter completion query.

18. The task based dialog system according to claim 10 wherein the query generator generates the first query using a template.

19. An electronic equipment for querying a database, the database storing data for completion of a task in a task based dialog system, the electronic equipment comprising:
means for interpreting a user input based on a task model and a dialog context to form an interpretation of the user input the dialog context comprising information provided by at least one of the user and the task based dialog system;
means for generating a first query based on the interpretation of the user input; and
means for converting the first query to a second query.
